(19) United States
(12) Patent Application Publication
(10) Pub. No.: US 2024/0256356 A1
(43) Pub. Date: Aug. 1, 2024

(54) LCS EMULATED-PHYSICAL-FUNCTION-ENABLED RESOURCE SYSTEM

(71) Applicant: Dell Products L.P., Round Rock, TX (US)

(72) Inventors: Douglas Lang Farley, Round Rock, TX (US); Srinivas Giri Raju Gowda, Fremont, CA (US); David Craig Lawson, Richardson, TX (US); Trevor Christian Cockrell, Hutto, TX (US); Shawn Mathew Swanson, Chanhassen, MN (US)

(21) Appl. No.: 18/427,022

(22) Filed: Jan. 30, 2024

Related U.S. Application Data
(63) Continuation-in-part of application No. 18/160,738, filed on Jan. 27, 2023.

(51) Int. Cl. G06F 9/50; G06F 9/54

(52) U.S. Cl. CPC G06F 9/5055; G06F 9/541

(57) ABSTRACT

An LCS ePF-enabled resource system includes a resource system coupled to a resource management system and resource device(s) configured to provide resource functionality. The resource system includes a microvisor subsystem that the resource management system configures to provide an LCS and an ePF that is presented to the LCS as providing the resource functionality. When the microvisor subsystem receives an LCS request for the resource functionality from an LCS API subsystem in the LCS via the ePF, it transmits a microvisor request to the resource management system for the resource functionality that causes the resource management system to identify the resource device(s) for providing the resource functionality. Based on the identification of the resource device(s), the microvisor subsystem establishes a communication channel with each resource device, and provides the resource functionality to the LCS using the resource device(s) and via each communication channel, the ePF, and the LCS API subsystem.

### CROSS-REFERENCE TO RELATED APPLICATION

The present disclosure is a Continuation-In-Part (CIP) of U.S. patent application Ser. No. 18/160,738, filed on Jan. 27, 2023, the disclosure of which is incorporated by reference in its entirety.

### BACKGROUND

The present disclosure relates generally to information handling systems, and more particularly to the use of emulated Physical Functions (ePFs) to enable the use of resources by a Logically Composed System (LCS) provided by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, may be used to provide users with Logically Composed Systems (LCSs) that include logical systems that perform workloads using the components in one or more server devices. Such LCSs enable the sharing of resources to provide more efficient resource usage, but the sharing of some resources between LCSs can raise issues. For example, Graphics Processing Units (GPUs) and other accelerator devices are designed for use via a single user interface with direct access to and from a userspace of an application process that utilizes the GPU/accelerator device, and typically include well-defined Application Programming Interfaces (APIs) that do not conventionally support the “multi-user” requirements that enable sharing of those resources between LCSs as described herein. Conventional solutions to such issues include developing custom APIs/Operating System (OS) libraries for such GPUs/accelerator devices that support the “multi-user” requirements discussed above. However, the use of such custom APIs/OS libraries carries with it the need to maintain and update those custom APIs/OS libraries, as well as the difficulties with ensuring that users regularly update those custom APIs/OS libraries.

Accordingly, it would be desirable to provide an LCS resource system that addresses the issues discussed above.

### SUMMARY

According to one embodiment, an Information Handling System (IHS) includes a microvisor processing system; and a microvisor memory system that is coupled to the microvisor processing system and that includes instructions that, when executed by the microvisor processing system, cause the microvisor processing system to provide a microvisor engine that is configured to: provide, in response to LCS configuration operations by a resource management system that is coupled to the microvisor processing system, a Logically Composed System (LCS) and an emulated Physical Function (ePF) that is presented to the LCS as providing resource functionality; receive, from an LCS Application Programming Interface (API) subsystem in the LCS via the ePF, an LCS request for the resource functionality; transmit, to the resource management system, a microvisor request for the resource functionality that is configured to cause the resource management system to identify at least one resource device for providing the resource functionality; establish, with each of the at least one resource device based on the resource management system identifying the at least one resource device for providing the resource functionality, a respective communication channel; and provide, to the LCS using the at least one resource device, the resource functionality via each respective communication channel, the ePF, and the LCS API subsystem.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a schematic view illustrating an embodiment of an LCS provisioning system that may provide the LCS ePF-enabled resource system for the present disclosure.

FIG. 8 is a schematic view illustrating an embodiment of a resource management system that may be included in the LCS provisioning system of FIG. 7.

FIG. 9 is a flow chart illustrating an embodiment of a method for enabling resources for an LCS using ePFs.

FIG. 10 is a schematic view illustrating an embodiment of the operation of the LCS provisioning system of FIG. 7 during the method of FIG. 9.

FIG. 11A is a schematic view illustrating an embodiment of the operation of the LCS provisioning system of FIG. 7 during the method of FIG. 9.

FIG. 11B is a schematic view illustrating an embodiment of the operation of the LCS provisioning system of FIG. 7 during the method of FIG. 9.

FIG. 12A is a schematic view illustrating an embodiment of the operation of the LCS provisioning system of FIG. 7 during the method of FIG. 9.

FIG. 12B is a schematic view illustrating an embodiment of the operation of the LCS provisioning system of FIG. 7 during the method of FIG. 9.

FIG. 13A is a schematic view illustrating an embodiment of the operation of the LCS provisioning system of FIG. 7 during the method of FIG. 9.

FIG. 13B is a schematic view illustrating an embodiment of the operation of the LCS provisioning system of FIG. 7 during the method of FIG. 9.

FIG. 13C is a schematic view illustrating an embodiment of the operation of the LCS provisioning system of FIG. 7 during the method of FIG. 9.

FIG. 14A is a schematic view illustrating an embodiment of the operation of the LCS provisioning system of FIG. 7 during the method of FIG. 9.

FIG. 14B is a schematic view illustrating an embodiment of the operation of the LCS provisioning system of FIG. 7 during the method of FIG. 9.

FIG. 14C is a schematic view illustrating an embodiment of the operation of the LCS provisioning system of FIG. 7 during the method of FIG. 9.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

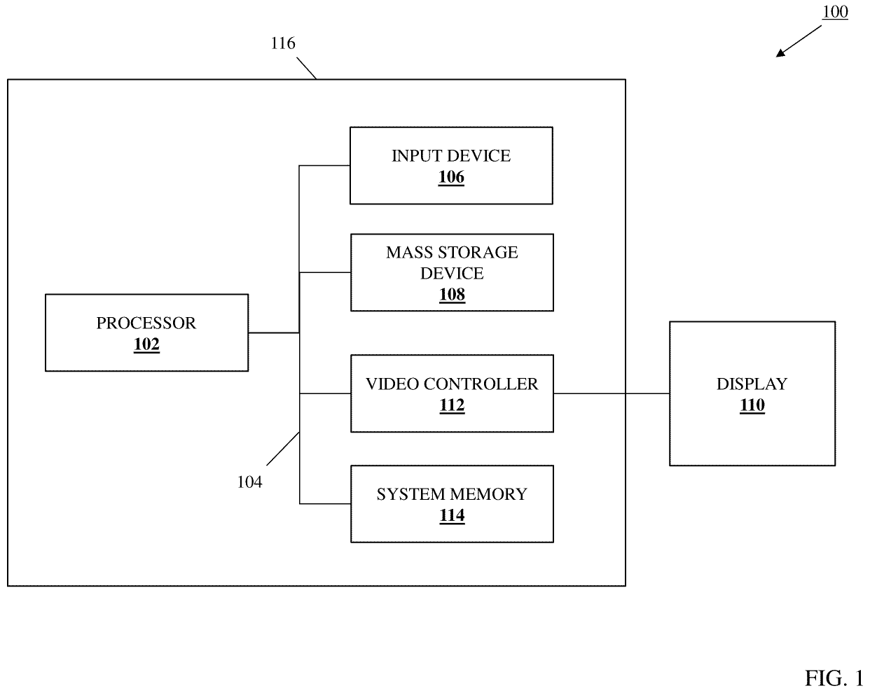

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the Logically Composed System (LCS) emulated Physical Function (ePF)-enabled resource systems and methods of the present disclosure may be utilized with LCSs, which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

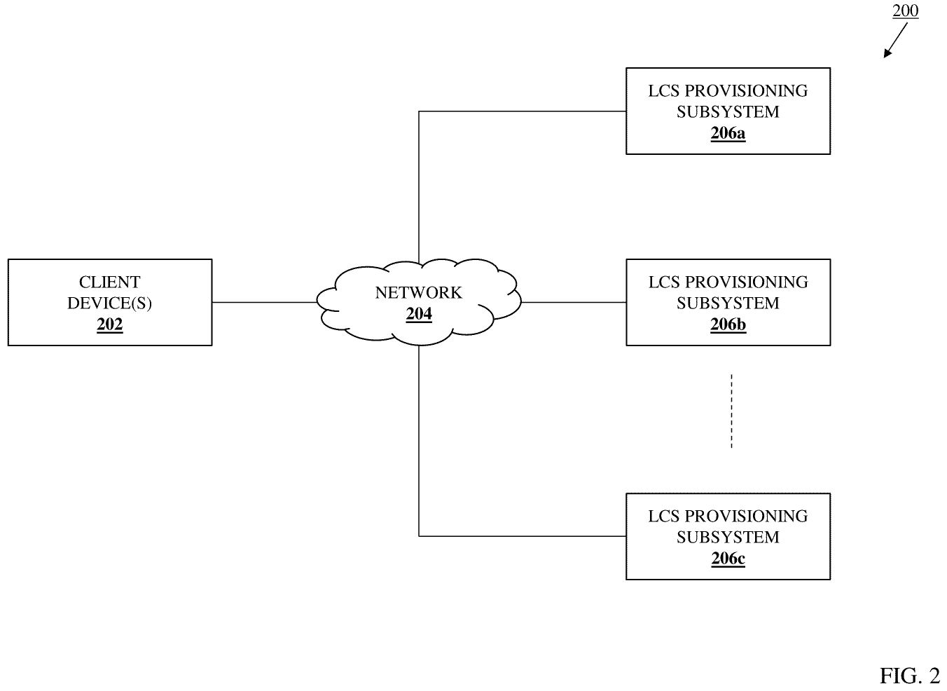

With reference to FIG. 2, an embodiment of a Logically Composed System (LCS) provisioning system 200 is illustrated that may be utilized with the LCS ePF-enabled resource systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

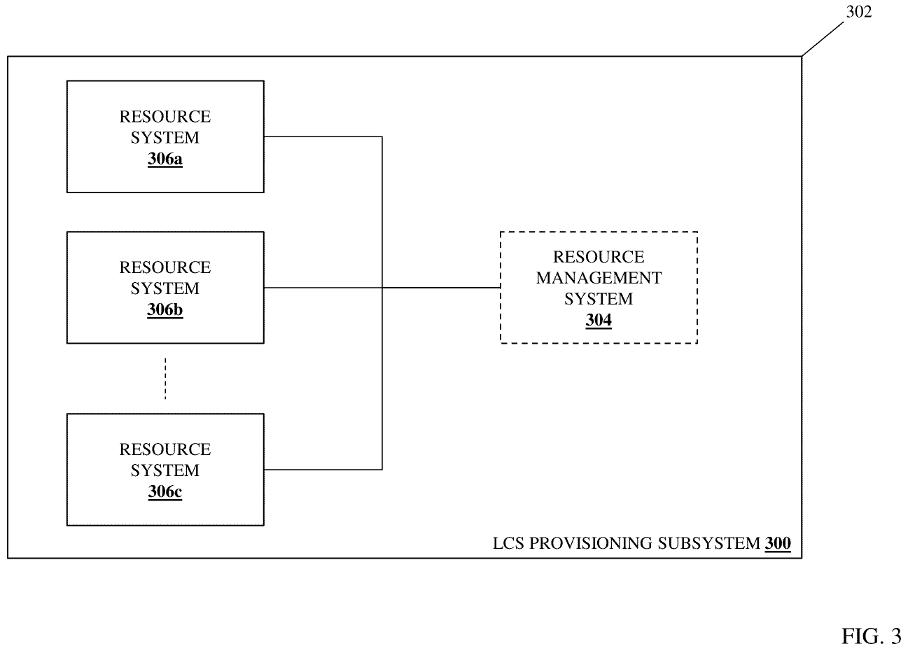

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

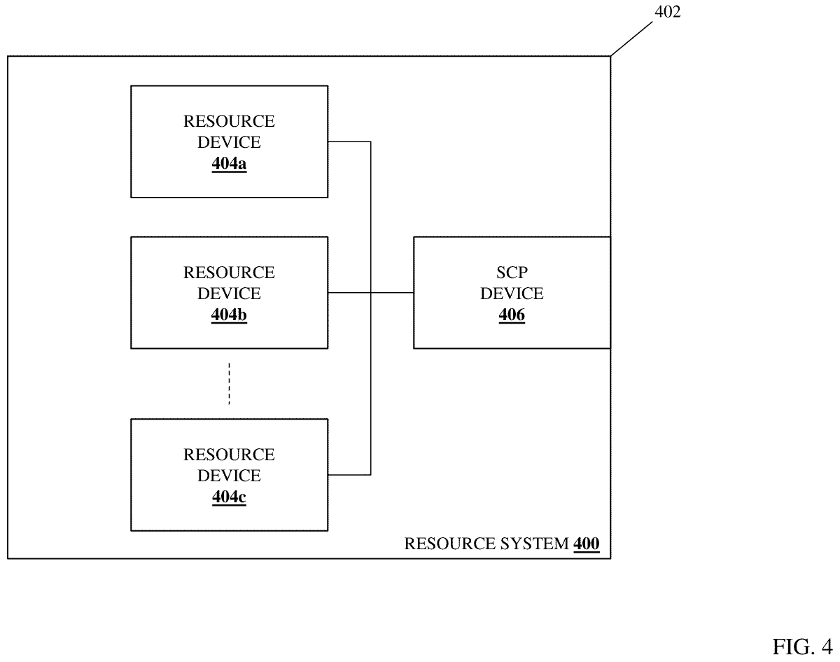

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciated that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

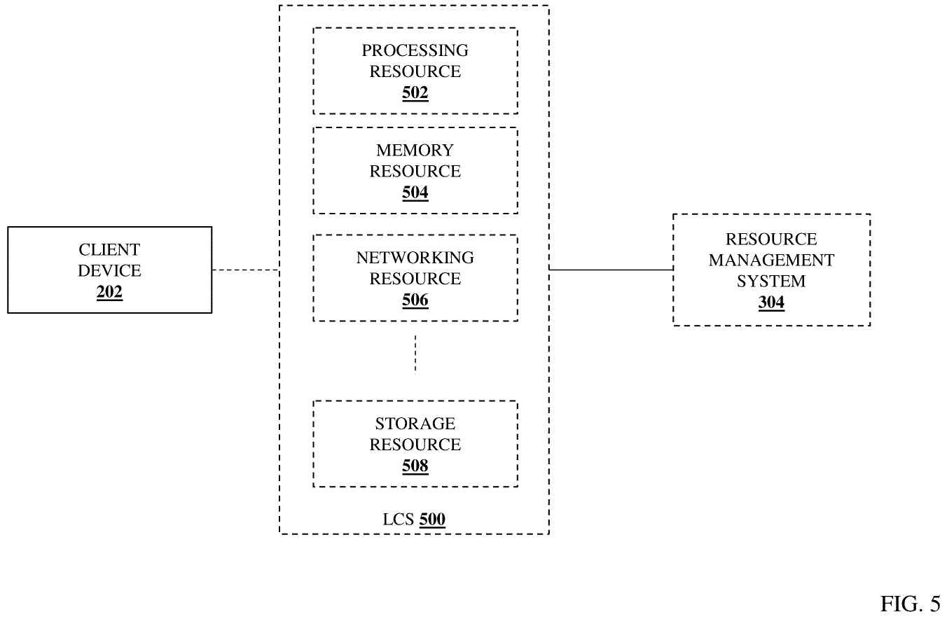

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

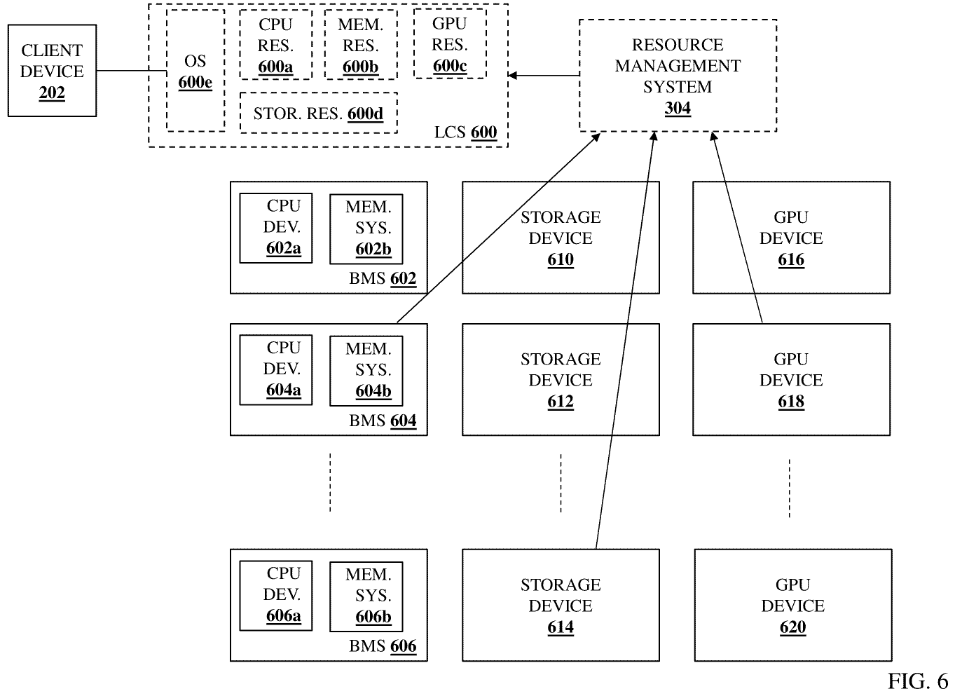

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

As described above, while LCSs enable the sharing of resource devices to provide more efficient resource usage, the sharing of resource devices like GPUs and other accelerator devices between LCSs can raise issues, as such resource devices are designed for use via a single user interface with direct access to and from a userspace of an application process that utilizes the resource device, and typically include well-defined APIs that do not conventionally support the “multi-user” requirements that enable sharing of resource devices between LCSs as described above. Furthermore, conventional solutions to such issues are undesirable, as the development of custom APIs/OS libraries for such resource devices that support the “multi-user” requirements discussed above carry with them the need to maintain and update those custom APIs/OS libraries, as well as the difficulties with ensuring that users regularly update those custom APIs/OS libraries.

Some of the inventors of the present disclosure have developed techniques for virtualizing peripheral devices like the resource devices discussed above using emulated Physical Functions (ePFs) in U.S. patent application Ser. No. 18/160,738, filed on Jan. 27, 2023, the disclosure of which is incorporated by reference in its entirety, and the inventors of the present disclosure have leveraged those teachings to develop the LCS ePF-enabled resource systems and methods of the present disclosure that provide ePFs that enable LCSs to share resource devices using conventional resource device APIs.

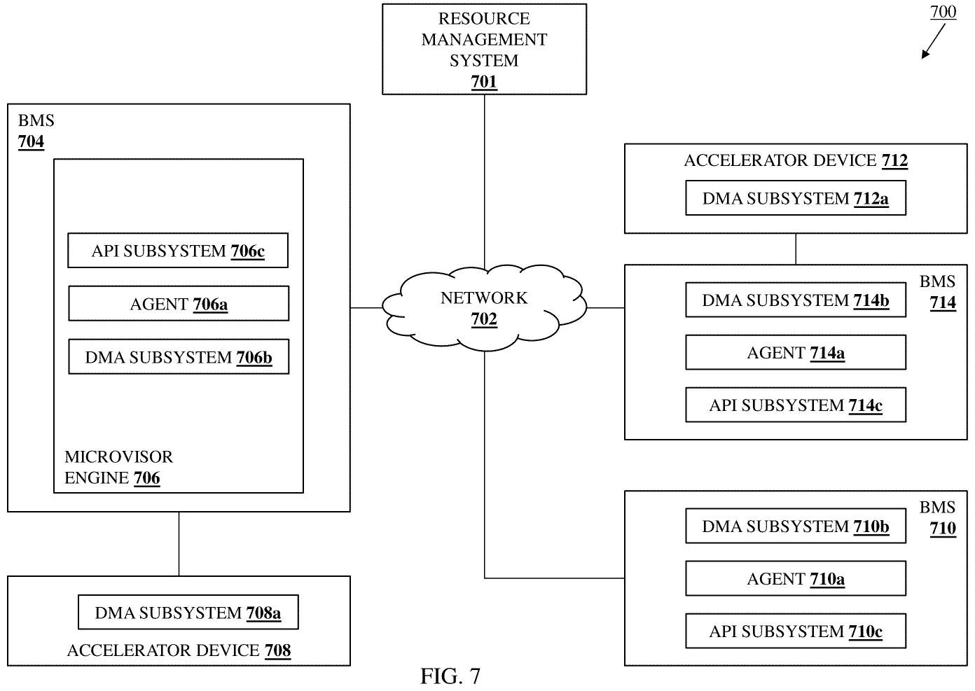

Referring now to FIG. 7, an embodiment of an LCS provisioning system 700 is illustrated that may provide the LCS ePF-enabled resource system of the present disclosure. In the illustrated embodiment, the LCS provisioning system 700 includes a resource management system 701 that may be provided by the resource management system 304 discussed above with reference to FIG. 3 (e.g., a SCPM subsystem as described above). In the illustrated embodiment, the resource management system 701 is coupled to a network 702 that may be provided by the network 204 discussed above with reference to FIG. 2, and thus may be provided by a Local Area Network (LAN), a Wide Area Network (WAN), the Internet, combinations thereof, and/or any other network that would be apparent to one of skill in the art in possession of the present disclosure.

In the embodiments illustrated and described below, the LCS provisioning system 700 includes a resource system that is provided by a BMS 704 that may include any of the resource systems 306a-306c discussed above with reference to FIG. 3, the resource system 400 discussed above with reference to FIG. 4, the BMSs 602, 604, and 606 discussed above with reference to FIG. 6, and/or other resource systems that would be apparent to one of skill in the art in possession of the present disclosure. As illustrated, the BMS 704 may include a memory system (e.g., any of the memory systems in the BMSs 602-606 discussed above) that includes instruction that, when executed by a processing system in the BMS 704 (e.g., any of the CPU devices in the BMSs 602-606 described above), cause the processing system to provide a microvisor engine 706 that is configured to perform any of the functionality (e.g., the LCS provisioning functionality of any of the LCSs described herein) of the microvisor engines, microvisor subsystems, and/or BMSs described below.

In the specific example illustrated in FIG. 7 and described below, the microvisor engine 706 may be configured to provide an agent 706a that, as described in further detail below, may be configured to establish communication channels with remote resource devices and/or perform any other agent functionality that one of skill in the art in possession of the present disclosure would recognize as providing the functionality described below. The microvisor engine 706 may also be configured to provide a Direct Memory Access (DMA) subsystem 706b (e.g., including a DMA service, a DMA engine, etc.) that, as described in further detail below, may be configured to perform DMA operations with resource devices and/or perform any other DMA functionality that one of skill in the art in possession of the present disclosure would recognize as providing the functionality described below. The microvisor engine 706 may also be configured to provide an Application Programming Interface (API) subsystem 706c (e.g., including an API service, an API engine, etc.) that, as described in further detail below, may be configured to perform API operations with resource devices and/or perform any other API functionality that one of skill in the art in possession of the present disclosure would recognize as providing the functionality described below.

In the illustrated embodiment, the BMS 704 includes a “local” resource device that is provided by an accelerator device 708 that one of skill in the art in possession of the present disclosure will appreciate may be connected to the BMS 704 via a Peripheral Component Interconnect express (PCIe) connection and/or other “local”/non-network connection that would be apparent to one of skill in the art in possession of the present disclosure. As described in further detail below, the “local” resource device provided by the accelerator device 708 (e.g., a GPU or other accelerator device known in the art) may be configured to perform resource functionality such as the accelerator functionality described below.

In the specific example illustrated in FIG. 7 and described below, the accelerator device 708 may be configured with a DMA subsystem 708a (e.g., including a DMA engine, etc.) that, as described in further detail below, may be configured to perform DMA operations with the BMS 704 (or other resource systems) and/or perform any other DMA functionality that one of skill in the art in possession of the present disclosure would recognize as providing the functionality described below. Furthermore, while not illustrated or described in detail, one of skill in the art in possession of the present disclosure will appreciate how the accelerator device 708 may include physical functions and/or virtual functions that are used to control the accelerator device 708 as described below. However, while a single, specific “local” resource device is illustrated and described, one of skill in the art in possession of the present disclosure will appreciate how any number and/or type of “local” resource devices may be provided for the BMS 704 (or other resource system) while remaining within the scope of the present disclosure as well.

In the illustrated embodiment, the BMS 704 also includes a “remote” resource device that is provided by a resource system including a BMS 710 that is coupled to the BMS 704 via the network 702. As described in further detail below, the “remote” resource device provided by the BMS 710 may be configured to perform resource functionality such as the accelerator functionality described below. Similarly as described above, the BMS 710 may be provided by any of the resource systems 306a-306c discussed above with reference to FIG. 3, the resource system 400 discussed above with reference to FIG. 4, the BMSs 602, 604, and 606 discussed above with reference to FIG. 6, and/or any other resource systems that would be apparent to one of skill in the art in possession of the present disclosure.

In the specific example illustrated in FIG. 7 and described below, the BMS 710 may be configured to provide an agent 710a that, as described in further detail below, may be configured to establish communication channels with resource systems like the BMS 704 and/or perform any other agent functionality that one of skill in the art in possession of the present disclosure would recognize as providing the functionality described below. The BMS 710 may also be configured to provide a DMA subsystem 710b (e.g., including a DMA engine(s), etc.) that, as described in further detail below, may be configured to perform DMA operations with resource systems like the BMS 704 and/or perform any other DMA functionality that one of skill in the art in possession of the present disclosure would recognize as providing the functionality described below. The BMS 710 may also be configured to provide an API subsystem 710c (e.g., including an API service, an API engine, etc.) that, as described in further detail below, may be configured to perform API operations with resource systems like the BMS 704 and/or perform any other API functionality that one of skill in the art in possession of the present disclosure would recognize as providing the functionality described below. Furthermore, while not illustrated or described in detail, one of skill in the art in possession of the present disclosure will appreciate how the BMS 710 may include physical functions and/or virtual functions that are used to control the BMS 710 as described below.

In the illustrated embodiment, the BMS 704 also includes a “remote” resource device that is provided by resource system/resource device combination that includes an accelerator device 712 connected to a BMS 714 that is coupled to the BMS 704 via the network 702. As described in further detail below, the “remote” resource device provided by the accelerator device 712 (e.g., a GPU or other accelerator device known in the art) may be configured to perform resource functionality such as the accelerator functionality described below. In the specific example illustrated in FIG. 7 and described below, the accelerator device 712 may be configured with a DMA subsystem 712a (e.g., including a DMA engine, etc.) that, as described in further detail below, may be configured to perform DMA operations with the BMS 704 (or other resource systems) and/or perform any other DMA functionality that one of skill in the art in possession of the present disclosure would recognize as providing the functionality described below.

Similarly as described above, the BMS 714 may be provided by any of the resource systems 306a-306c discussed above with reference to FIG. 3, the resource system 400 discussed above with reference to FIG. 4, the BMSs 602, 604, and 606 discussed above with reference to FIG. 6, and/or any other resource systems that would be apparent to one of skill in the art in possession of the present disclosure. In the specific example illustrated in FIG. 7 and described below, the BMS 714 may be configured to provide an agent 714a that, as described in further detail below, may be configured to establish communication channels with resource systems like the BMS 704 and resource devices like the accelerator device 712, and/or perform any other agent functionality that one of skill in the art in possession of the present disclosure would recognize as providing the functionality described below. The BMS 714 may also be configured to provide a DMA subsystem 714b (e.g., including a DMA engine(s), etc.) that, as described in further detail below, may be configured to perform DMA operations with resource systems like the BMS 704 and resource devices like the accelerator device 712, and/or perform any other DMA functionality that one of skill in the art in possession of the present disclosure would recognize as providing the functionality described below. Furthermore, while not illustrated or described in detail, one of skill in the art in possession of the present disclosure will appreciate how the accelerator device 712 may include physical functions and/or virtual functions that are used to control the accelerator device 712 as described below.

The BMS 714 may also be configured to provide an API subsystem 714c (e.g., including an API service, an API engine, etc.) that, as described in further detail below, may be configured to perform API operations with resource systems like the BMS 704 and/or perform any other API functionality that one of skill in the art in possession of the present disclosure would recognize as providing the functionality described below. However, while a specific LCS provisioning system 700 has been illustrated and described, one of skill in the art in possession of the present disclosure will recognize that the LCS ePF-enabled resource system of the present disclosure may include a variety of components and component configurations while remaining within the scope of the present disclosure as well.

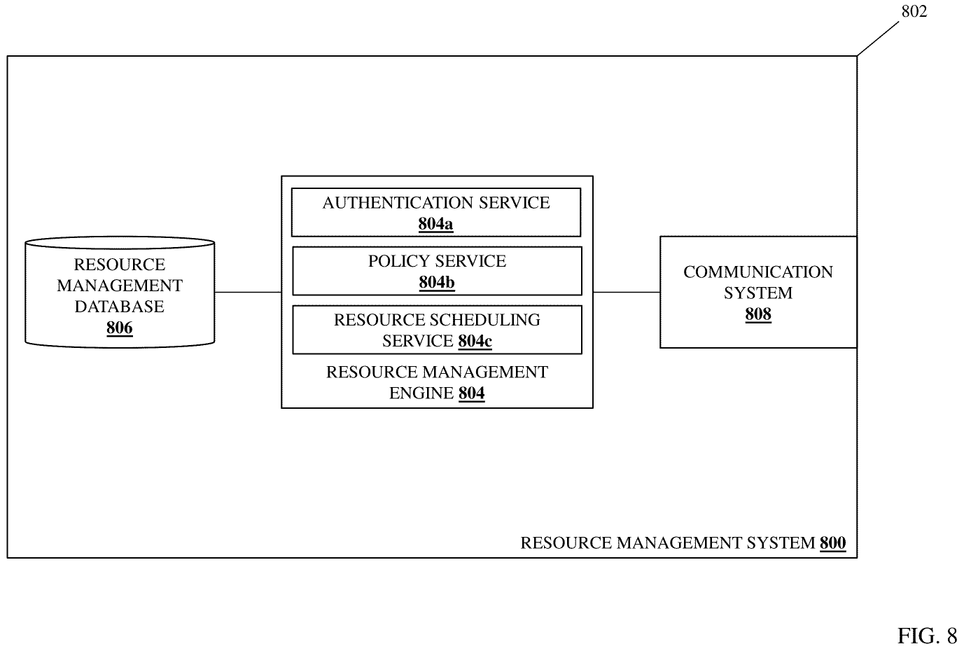

Referring now to FIG. 8, an embodiment of a resource management system 800 is illustrated that may provide the resource management system 701 discussed above with reference to FIG. 7. As such, the resource management system 800 may be provided by the resource management system 304 discussed above with reference to FIG. 3 (e.g., an SCPM subsystem in the examples provided above). In the illustrated embodiment, the resource management system 800 includes a chassis 802 that houses the components of the resource management system 800, only some of which are illustrated and described below. For example, the chassis 802 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a resource management engine 804 that is configured to perform the functionality of the resource management engines and/or resource management systems discussed below.

In the specific examples provided below, the resource management engine 804 is configured to provide an authentication service 804a that may be configured to perform authentication operations for any of the LCSs provided as described below, a policy service 804b that may be configured to apply policies to the operation of any of the LCSs provided as described below, and a resource scheduling service 804c that may be configured to provide any of the LCSs described below with resource devices, although one of skill in the art in possession of the present disclosure will appreciate how the resource management engine 804 may be configured to provide a variety of other services in order to enable the functionality described below.

The chassis 802 may also house a storage system (not illustrated, but which may include the storage 108 discussed above with reference to FIG. 1) that is coupled to the resource management engine 804 (e.g., via a coupling between the storage system and the processing system) and that includes a resource management database 806 that is configured to store any of the information utilized by the resource management engine 804 discussed below. The chassis 802 may also house a communication system 808 that is coupled to the resource management engine 804 (e.g., via a coupling between the communication system 808 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. However, while a specific resource management system 800 has been illustrated and described, one of skill in the art in possession of the present disclosure will recognize that resource management systems (or other devices operating according to the teachings of the present disclosure in a manner similar to that described below for the resource management system 800) may include a variety of components and/or component configurations for providing conventional resource management functionality, as well as the functionality discussed below, while remaining within the scope of the present disclosure as well.

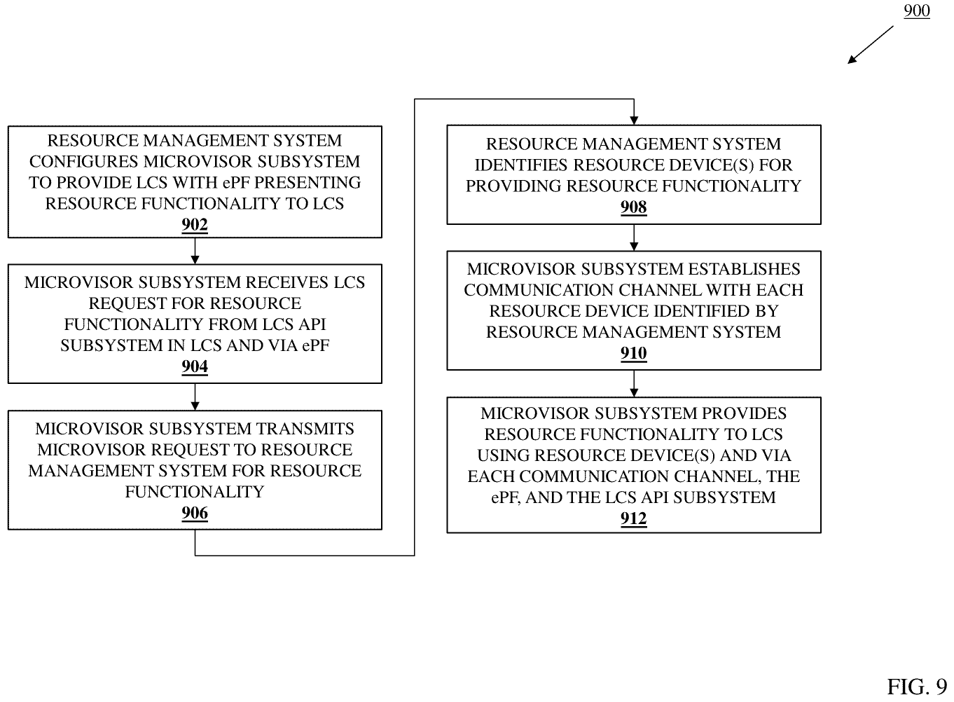

Referring now to FIG. 9, an embodiment of a method 900 for enabling resources for an LCS using ePFs is illustrated. As discussed below, the systems and methods of the present disclosure present resource functionality to an LCS using an ePF that interacts with an LCS API subsystem in the LCS and allows for the execution of resource functionality requests received from that LCS API subsystem using any of a variety of resource devices. For example, the LCS ePF-enabled resource system of the present disclosure may include a resource system coupled to a resource management system and resource device(s) configured to provide resource functionality.

The resource system includes a microvisor subsystem that the resource management system configures to provide an LCS and an ePF that is presented to the LCS as providing the resource functionality. When the microvisor subsystem receives an LCS request for the resource functionality from an LCS API subsystem in the LCS via the ePF, it transmits a microvisor request to the resource management system for the resource functionality that causes the resource management system to identify the resource device(s) for providing the resource functionality. Based on the identification of the resource device(s), the microvisor subsystem establishes a communication channel with each resource device, and provides the resource functionality to the LCS using the resource device(s) and via each communication channel, the ePF, and the LCS API subsystem. As such, resource devices that include conventional APIs that are designed for use with single user interfaces may be utilized by multiple LCSs without modification to those conventional APIs.

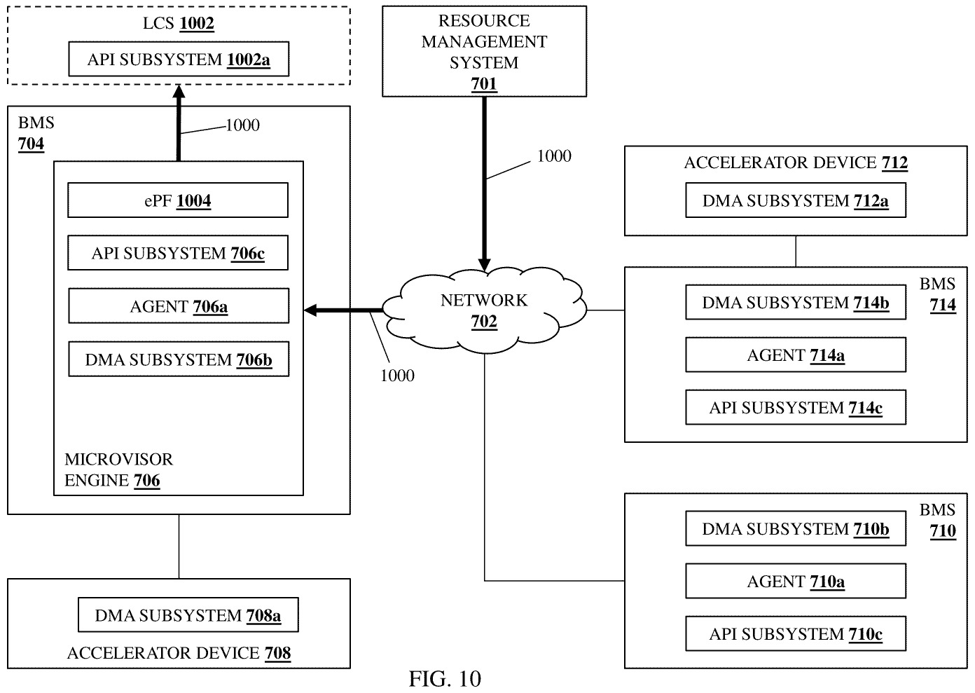

The method 900 begins at block 902 where a resource management system configures a microvisor subsystem to provide an LCS with an ePF presenting resource functionality to the LCS. With reference to FIG. 10, in an embodiment of block 902, the resource management system 701 may perform microvisor/LCS configuration operations 1000 that include configuring the microvisor engine 706 in the BMS 704 via the network 702 to cause the microvisor engine 706 to provide an LCS 1002, and one of skill in the art in possession of the present disclosure will appreciate how the microvisor engine 706 may be configured to provide the LCS 1002 at block 902 using any of the LCS provisioning techniques described above. For example, the microvisor engine 706 may be configured to provide the LCS 1002 using a processing system (e.g., the CPU devices discussed above) and a memory system in the BMS 704, as well as any other resource devices required to satisfy a workload intent received for the LCS 1002 as described above.

As illustrated in FIG. 10, as part of the configuration of the microvisor engine 706 to provide the LCS 1002, the microvisor engine 706 may be configured with an emulated Physical Function (ePF) 1004 that is configured to present the LCS 1002 with resource functionality such as the accelerator functionality described below that may be required to satisfy a workload intent received for the LCS 1002 as described above. As discussed above, some of the inventors of the present disclosure have described techniques for virtualizing peripheral device control using emulated Physical Functions (ePFs) in U.S. patent application Ser. No. 18/160,738, filed on Jan. 27, 2023, the disclosure of which is incorporated by reference in its entirety. Similarly as described in that application, the ePFs discussed herein may be generated for peripheral devices in order to facilitate policy-based usage of functionalities of those peripheral devices, allow for unused capacity of those peripheral devices to be allocated to LCSs requesting those functionalities, and provide “composite” peripheral devices that combine the functionality available from multiple peripheral devices. As such, the ePF 1004 may be provided by the microvisor engine 706 using any of the ePF provisioning operations described in that application, although one of skill in the art in possession of the present disclosure will appreciate how the ePF may be provided using other ePF provisioning techniques while remaining within the scope of the present disclosure as well.

As illustrated, the LCS 1002 may be provided with an API subsystem 1002a that is described below as being provided by a conventional API subsystem that is configured to interact or otherwise interface with any of the resource devices provided by the accelerator device 708, the BMS 710, and the accelerator device 712/BMS 714 described below. As such, one of skill in the art in possession of the present disclosure will appreciate how the API subsystem 1002a in the LCS 1002 may include the conventional “well-defined” API and conventional OS library discussed above that are conventionally utilized with resource devices like the GPUs or other accelerator devices described above that are designed to operate with single user interfaces.

Thus, one of skill in the art in possession of the present disclosure in the art in possession of the present disclosure will appreciate how the ePF 1004 may only need to be configured to provide the API functionality described herein (e.g., the ePF 1004 need only be configured to conform with the API subsystem 1002a) that enables multi-user interaction with resource devices like the GPUs or other accelerator devices described above that are designed to operate with single user interfaces, and thus may not require other conventional physical function functionality (e.g., resource device temperature monitoring, etc.). To provide a specific example, the API subsystem 1002a may be provided by an Radeon Open Compute platform (ROCm) software stack available from Advanced Micro Devices (AMD®) of Santa Clara, California, United Stone of skill in the art in possession of the present disclosure one of skill in the art in possession of the present disclosure will appreciate supports an Open Compute Language (OpenCL) interface and other interfaces (including container support interfaces), includes a userspace driver requiring access to a “/dev/kfd” AMD character device and “/dev/dri/render #”, and operates with a render target provided by a Linux Direct Rendering Manager (DRM)-compatible endpoint that includes separate owner/user privilege separation. As such, the ePF 1004 used with the API subsystem 1002a provided by an ROCm software stack need only conform to its API components provided by a versioned amdkfd and omap render node in order to provide the API intermediation described herein. However, while a specific example of an API subsystem provided by a ROCm software stack has been described, other API subsystems (e.g., API subsystems provided by an INTEL® Storage Acceleration Library (ISA-L) or INTEL® oneAPI available from INTEL® Corp. of Santa Clara, California, United States) will fall within the scope of the present disclosure as well.

As will be appreciated by one of skill in the art in possession of the present disclosure, the simplified example provided in FIG. 10 includes a single API subsystem 1002a and corresponding ePF 1004 for interacting with a plurality of different resource devices provided by the accelerator device 708, the BMS 710, and the accelerator device 712/BMS 714 described below, and thus each of the different resource devices provided by the accelerator device 708, the BMS 710, and the accelerator device 712/BMS 714 may be configured to interface or otherwise interact with that API subsystem 1002a. However, one of skill in the art in possession of the present disclosure will appreciate how the LCS 1002 may be provided with a respective API subsystem for interacting with each different type of accelerator device or other resource device that it will use, and thus how the microvisor engine 706 may be configured with a respective ePF for each API subsystem in the LCS 1002 that is configured to interact with those different types of accelerator devices or resource devices. As such, while a specific example of an API subsystem and an ePF for enabling the utilization of different resource devices/accelerator devices by an LCS is illustrated and described below, one of skill in the art in possession of the present disclosure will appreciate how the utilization of the different resource devices/accelerator devices by an LCS may be enabled in a variety of manners using the ePF/API subsystem techniques described herein.

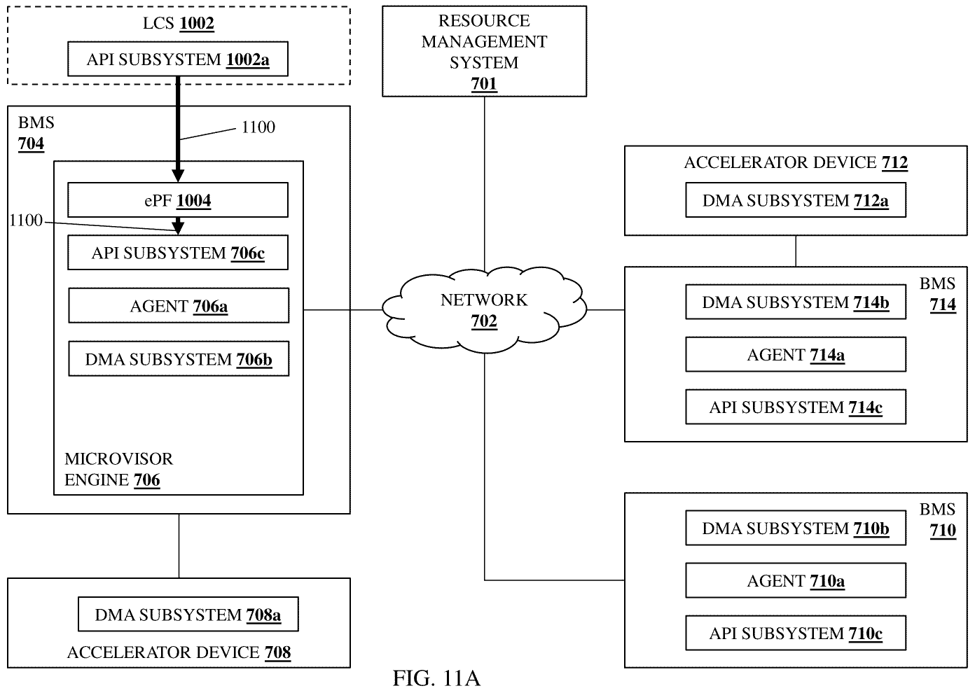

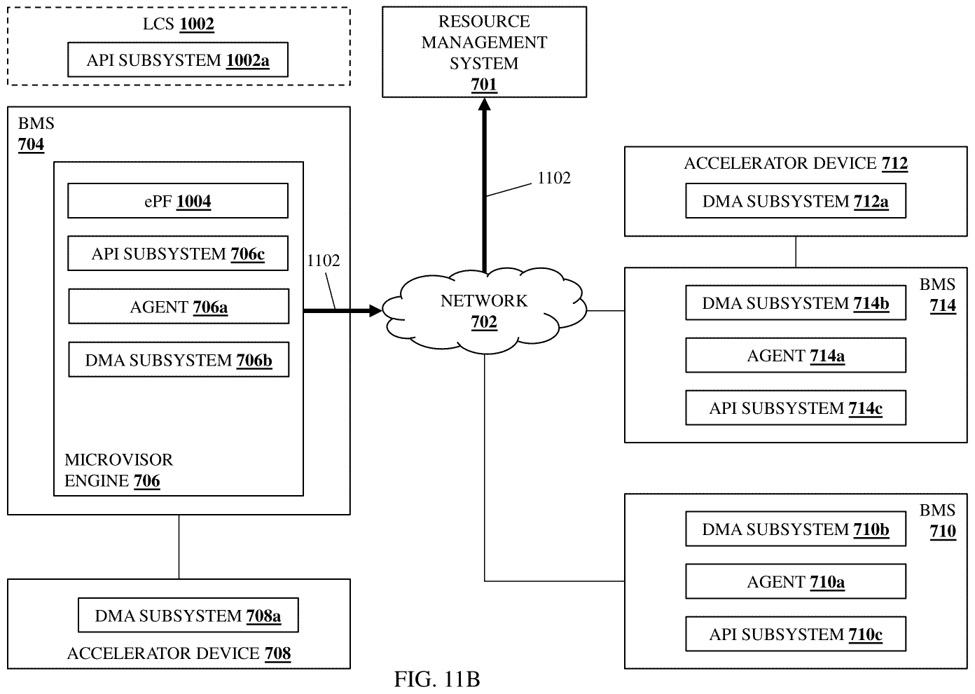

The method 900 then proceeds to block 904 where the microvisor subsystem receives an LCS request for resource functionality from an LCS API subsystem in the LCS via the ePF. With reference to FIG. 11A, in an embodiment of block 904, the LCS 1002 may perform LCS resource functionality request operations 1100 that include generating an LCS request for resource functionality that is presented to it by the ePF 1004, and using the API subsystem 1002a to transmit that LCS request to the ePF 1004 such that it is received by the API subsystem 706c via the ePF 1004. In the examples below, the resource functionality requested in the LCS request includes accelerator functionality, but one of skill in the art in possession of the present disclosure will appreciate how LCS requests may request any of a variety of resource functionality presented to them by the ePFs described herein while remaining within the scope of the present disclosure as well.

The method 900 then proceeds to block 906 where the microvisor subsystem transmits a microvisor request to the resource management system for resource functionality. With reference to FIG. 11B, in an embodiment of block 906 and in response to receiving the LCS request at block 904, the microvisor engine 706 may perform microvisor resource functionality request operations 1102 that include generating a microvisor request for a resource device to use in providing the resource functionality requested by the LCS at block 904, and transmitting that microvisor request via the network 702 and to the resource management engine 701. As such, the resource management engine 804 in the resource management system 701/800 may receive the microvisor request via its communication system 808 at block 906.

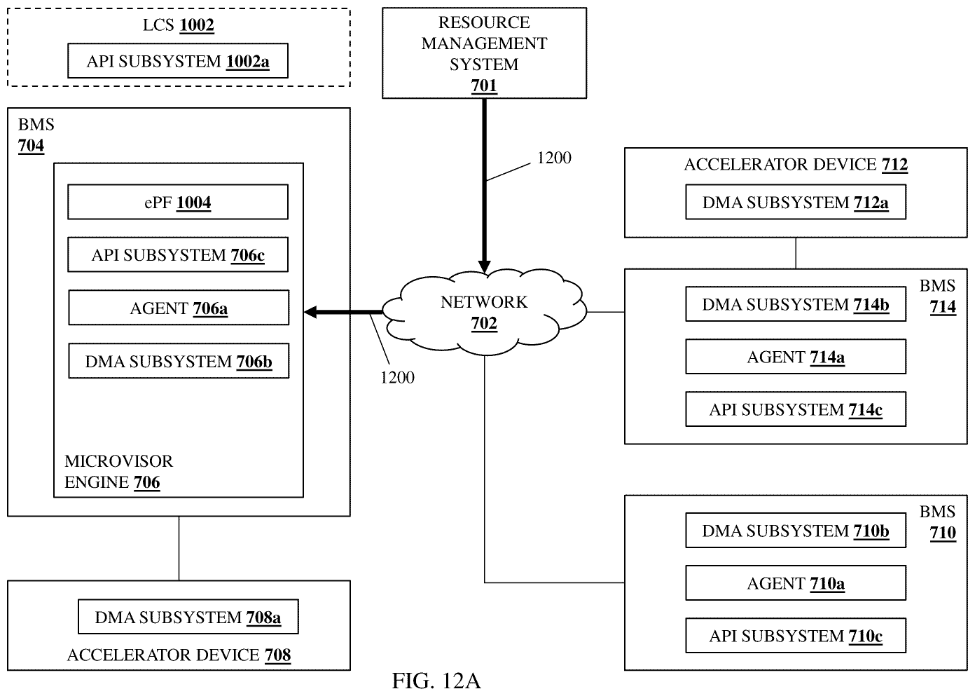

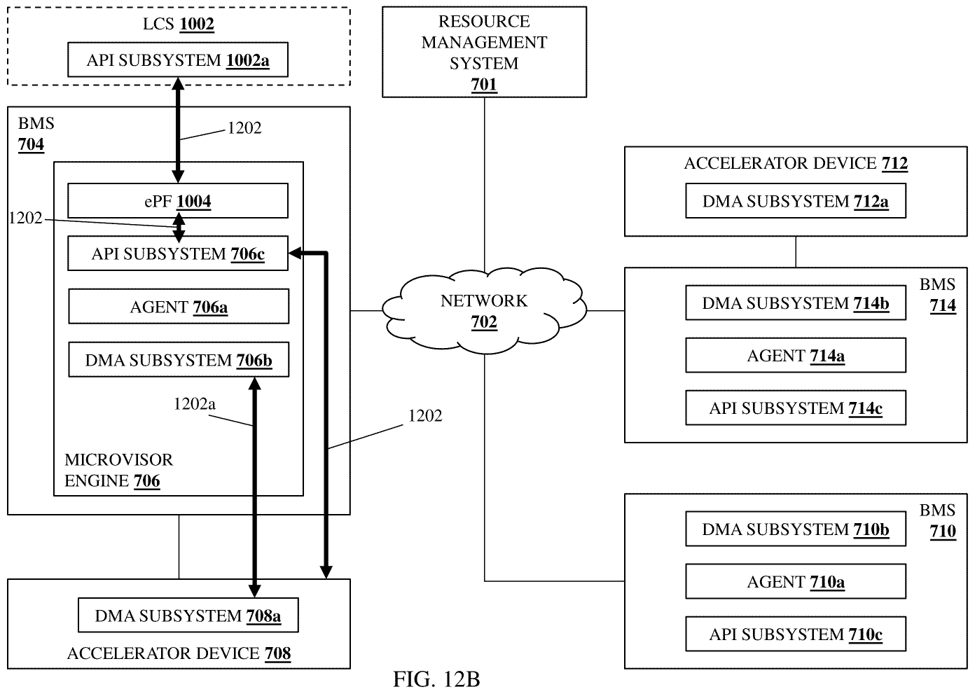

The method 900 then proceeds to block 908 where the resource management system identifies one or more resource devices for providing the resource functionality. With reference to FIG. 12A, in a first embodiment of block 908, the resource management engine 804 in the resource management system 701/800 may select a “local” resource device provided by the accelerator device 708 for providing the resource functionality. Similarly as described in in U.S. patent application Ser. No. 18/160,738 referenced above, the policy service 804b provided by the resource management system 701 may ensure that the request for resource functionality, the use of the accelerator device 708 to provide that resource functionality, and/or any other aspects of the use of the accelerator device 708 by the LCS 1002 to perform the resource functionality, are allowable per any policies associated with the LCS 1002. In response to selecting the accelerator device 708 for providing the resource functionality to the LCS 1002, the resource scheduling service 804c provided by the resource management engine 804 may schedule the use of the accelerator device 708 by the LCS 1002, and one of skill in the art in possession of the present disclosure will appreciate how such resource scheduling may include any time limits, functionality limits, and/or other scheduling limitations known in the art.

The authentication service 804a provided by the resource management engine 804 may then generate resource device identification information that may include connectivity details for the accelerator device 708, an authentication token needed to authenticate with the accelerator device 708, and/or any other information that one of skill in the art in possession of the present disclosure would recognize as being required to utilize the accelerator device 708 as described below. As illustrated in FIG. 12A, the resource management engine 804 in the resource management system 701/800 may then perform resource device identification operations 1200 that include identifying the accelerator device 708 to the microvisor engine 706 via the network 702.

As will be appreciated by one of skill in the art in possession of the present disclosure, the identification to the microvisor engine 706 of the “local” resource device provided by the accelerator device 708 may allow for the direct resource management system 701/microvisor engine 706 identification described above, and may include providing the microvisor engine 706 the connectivity details, authentication token, and other information discussed above that is required for the LCS 1002 to utilize the accelerator device 708 for the resource functionality as described below. However, the identification to the microvisor engine 706 of “remote” resource devices like those provided by the BMS 710 and accelerator device 712/BMS 714 may not allow for direct identification like that described above for the accelerator device 708.

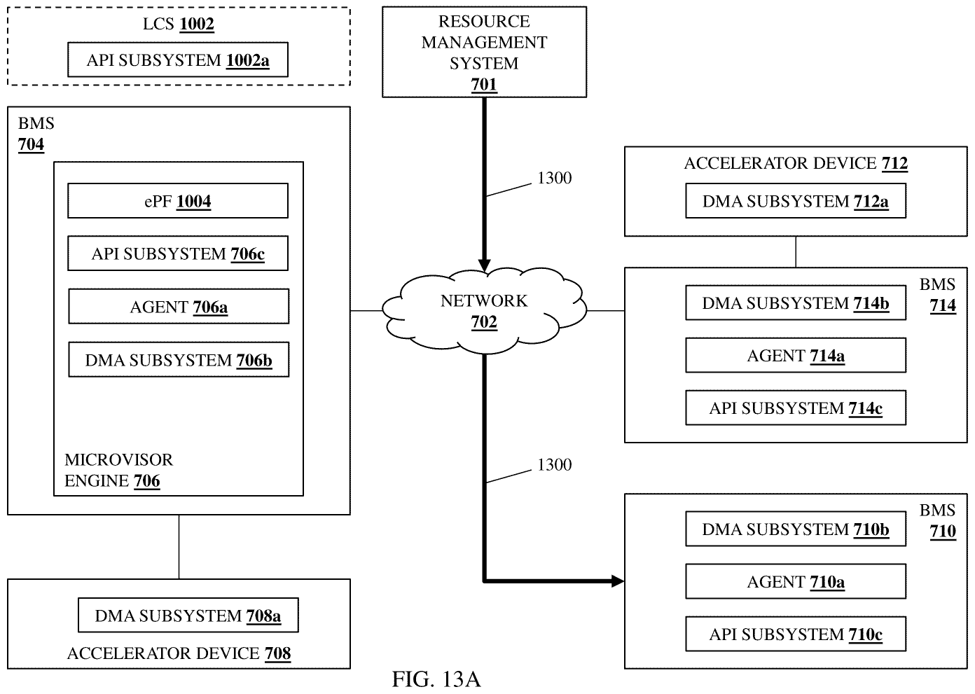

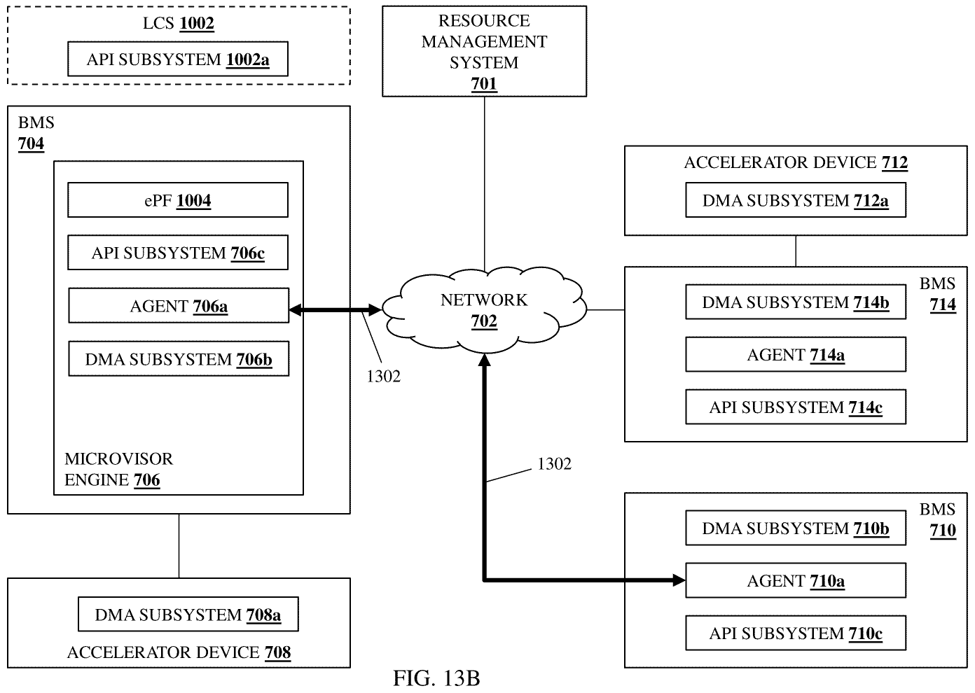

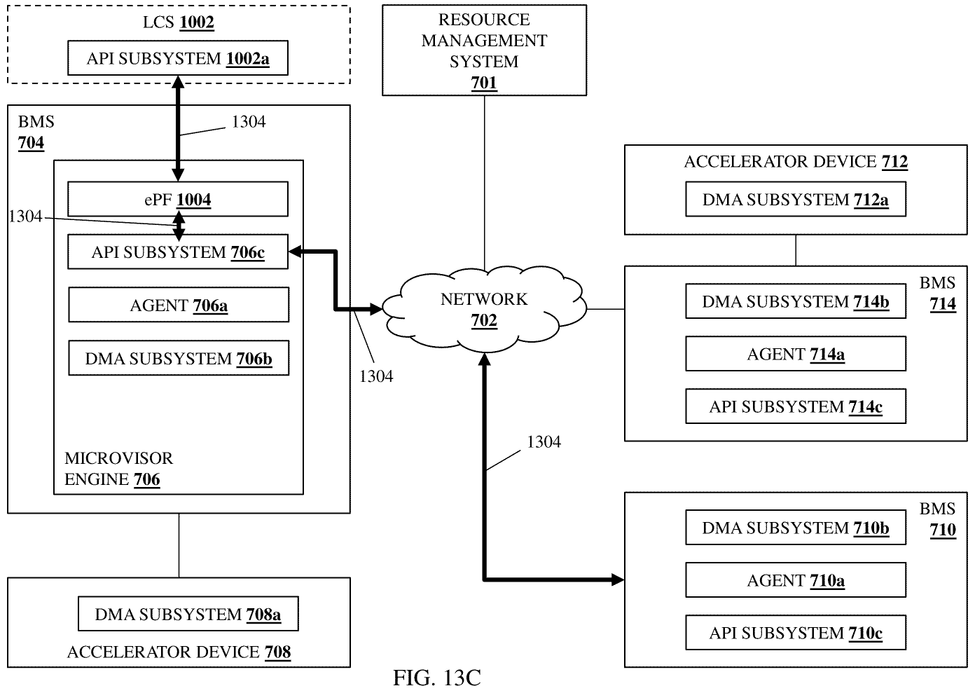

With reference to FIG. 13A, in a second embodiment of block 908, the resource management engine 804 in the resource management system 701/800 may select a “remote” resource device provided by the BMS 710 for providing the resource functionality. Similarly as described in in U.S. patent application Ser. No. 18/160,738 referenced above, the policy service 804b provided by the resource management system 701 may ensure that the request for resource functionality, the use of the BMS 710 to provide that resource functionality, and/or any other aspects of the use of the BMS 710 by the LCS 1002 to perform the resource functionality, are allowable per any policies associated with the LCS 1002. In response to selecting the BMS 710 for providing the resource functionality to the LCS 1002, the resource scheduling service 804c provided by the resource management engine 804 may schedule the use of the BMS 710 by the LCS 1002, and one of skill in the art in possession of the present disclosure will appreciate how such resource scheduling may include any time limits, functionality limits, and/or other scheduling limitations known in the art.

The authentication service 804a provided by the resource management engine 804 may then generate resource device identification information that may include connectivity details for the BMS 710, an authentication token needed to authenticate with the BMS 710, and/or any other information that one of skill in the art in possession of the present disclosure would recognize as being required to utilize the BMS 710 as described below. As illustrated in FIG. 13A, the resource management engine 804 in the resource management system 701/800 may then perform resource device identification operations 1300 that include instructing the BMS 710 via the network 702 to identify itself to the microvisor engine 706.

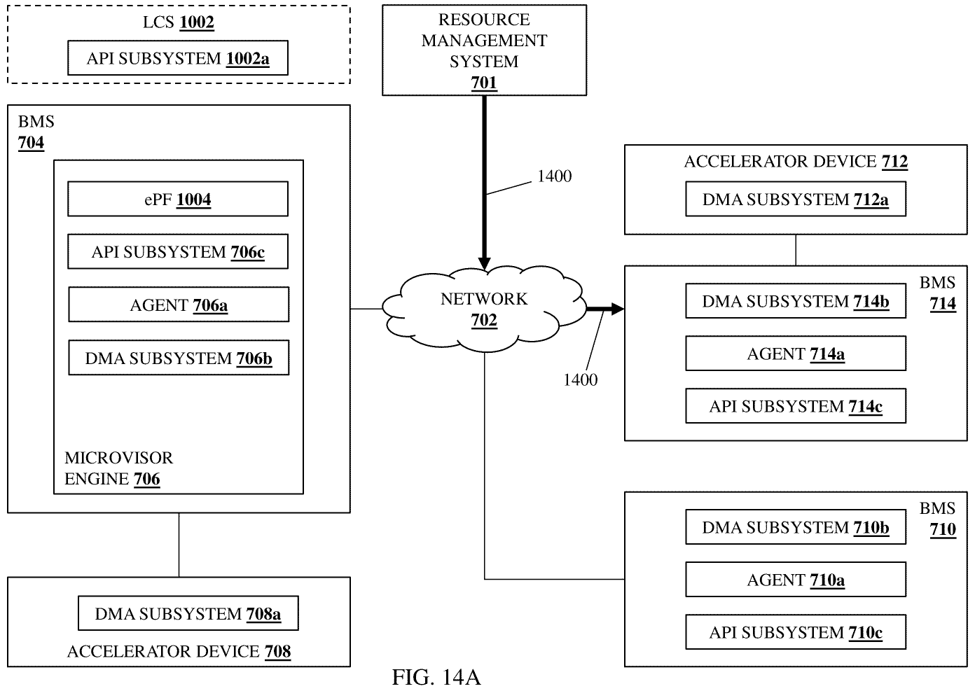

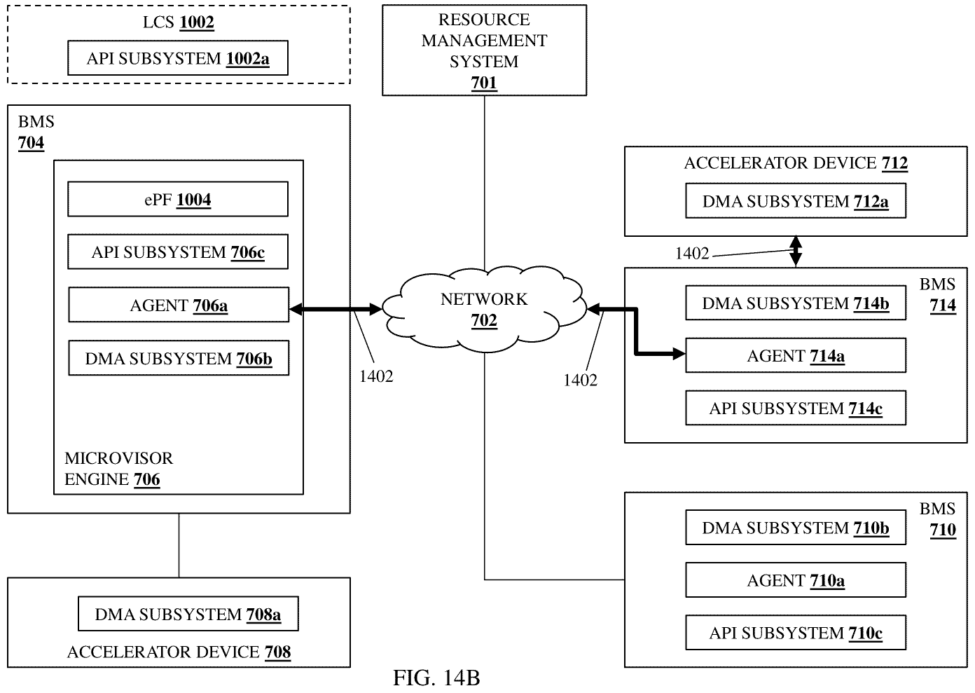

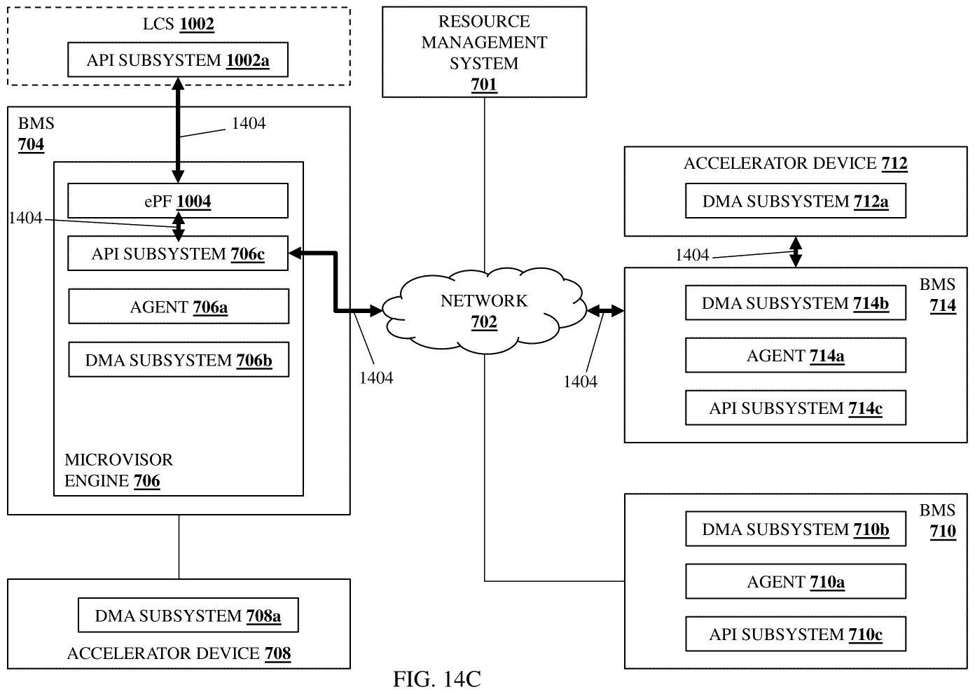

With reference to FIG. 14A, in a third embodiment of block 908, the resource management engine 804 in the resource management system 701/800 may select a “remote” resource device provided by the accelerator device 712/BMS 714 for providing the resource functionality. Similarly as described in U.S. patent application Ser. No. 18/160,738 referenced above, the policy service 804b provided by the resource management system 701 may ensure that the request for resource functionality, the use of the accelerator device 712/BMS 714 to provide that resource functionality, and/or any other aspects of the use of the accelerator device 712/BMS 714 by the LCS 1002 to perform the resource functionality are allowable per any policies associated with the LCS 1002. In response to selecting the accelerator device 712/BMS 714 for providing the resource functionality to the LCS 1002, the resource scheduling service 804c provided by the resource management engine 804 may schedule the use of the accelerator device 712/BMS 714 by the LCS 1002, and one of skill in the art in possession of the present disclosure will appreciate how such resource scheduling may include any time limits, functionality limits, and/or other scheduling limitations known in the art.

The authentication service 804a provided by the resource management engine 804 may then generate resource device identification information that may include connectivity details for the accelerator device 712/BMS 714, an authentication token needed to authenticate with the accelerator device 712/BMS 714, and/or any other information that one of skill in the art in possession of the present disclosure would recognize as being required to utilize the accelerator device 712/BMS 714 as described below. As illustrated in FIG. 14A, the resource management engine 804 in the resource management system 701/800 may then perform resource device identification operations 1400 that include instructing the agent 714a in the BMS 714 to identify the accelerator device 712 via the network 702 to the microvisor engine 706.

However, while the microvisor engine 706 is illustrated and described as requesting resource devices from the resource management system 701 for use in providing the resource functionality for the LCS 1002 in response to the request for that resource functionality from the LCS 1002, one of skill in the art in possession of the present disclosure will appreciate how the resource management system 701 may enable the use of resource devices for providing the resource functionality prior to the request for that resource functionality by the LCS 1002 while remaining within the scope of the present disclosure as well.

For example, as part of the configuration of the microvisor engine 706 to provide the LCS at block 902, the resource management engine 804 in the resource management system 701/800 may identify one or more resource devices (e.g., the accelerator device 708, the BMS 710, and the accelerator device 712/BMS 714) to the microvisor engine 706 that are available for use in providing the resource functionality, and may provide the microvisor engine 706 any of the connectivity details, authentication tokens, and/or other information for those resource devices similarly as described above. As such, the microvisor engine 706 may be configured with “pre-identified” resource devices that it may use to provide resource functionality requested by the LCS 1002 similarly as described below. As will be appreciated by one of skill in the art in possession of the present disclosure, such “pre-identification” of resource devices may be performed to deal with the possibility of resource functionality requests immediately following the provisioning of the LCS 1002, and the ability to use such resource devices may be time-limited (e.g., by the authentication tokens described above) such that, following the expiration of some time period, the microvisor engine 706 will be required to request those resource devices (or other resource devices) from the resource management system 701 similarly as described above in order to use them to perform the resource functionality requested by the LCS 1002.

The method 900 then proceeds to block 910 where the microvisor subsystem establishes a communication channel with each resource device identified by the resource management system. With reference to a first embodiment of block 910 that follows the first embodiment of block 908 discussed above in which the “local” resource device provided by the accelerator device 708 was identified to the microvisor engine 706, the communication channel between that “local” resource device/accelerator device 708 may have been previously established with the microvisor engine 706 as part of is provisioning as a “local” resource device for the LCS 1002.

With reference to FIG. 13B, and in a second embodiment of block 910 that follows the second embodiment of block 908 discussed above in which the “remote” resource device provided by the BMS 710 was identified to the microvisor engine 706, the agent 706b provided by the microvisor engine 706 and the agent 710a provided by the BMS 710 may perform communication channel establishment operations 1302 that operate to establish a communication channel between that “remote” resource device/BMS 710 and the microvisor engine 706. As will be appreciated by one of skill in the art in possession of the present disclosure, the communication channel establishment operations 1302 may include the agent 706a providing the authentication token for the BMS 710 to the agent 710a to authenticate its use of the BMS 710, configuring the communication channel between the BMS 710 and the microvisor engine 706, setting up a work queue for use in performing the resource functionality requested by the LCS 1002, transferring work via the agent 710a (e.g., for scheduling) that requires the performance of the resource functionality requested by the LCS 1002 by the BMS 710, and/or any other operations that one of skill in the art in possession of the present disclosure would recognize as providing the functionality described below.

With reference to FIG. 14B, and in a third embodiment of block 910 that follows the second embodiment of block 908 discussed above in which the “remote” resource device provided by the accelerator device 712/BMS 714 was identified to the microvisor engine 706, the agent 706b provided by the microvisor engine 706 and the agent 714a provided by the BMS 714 may perform communication channel establishment operations 1402 that operate to establish a communication channel between that “remote” resource device/accelerator device 712 and the microvisor engine 706. As will be appreciated by one of skill in the art in possession of the present disclosure, the communication channel establishment operations 1402 may include the agent 706a providing the authentication token for the accelerator device 712 to the agent 714a in the BMS 714 to authenticate its use of the accelerator device 712, configuring the communication channel between accelerator device 714 and the microvisor engine 706, setting up a work queue for use in performing the resource functionality requested by the LCS 1002, transferring work via the agent 714a in the BMS 714 (e.g., for scheduling) that requires the performance of the resource functionality requested by the LCS 1002 by the accelerator device 712, and/or any other operations that one of skill in the art in possession of the present disclosure would recognize as providing the functionality described below.

The method 900 then proceeds to block 912 where the microvisor subsystem provides the resource functionality to the LCS using the resource device(s) and via each communication channel, the ePF, and the LCS API subsystem. With reference to FIG. 12B, in a first embodiment of block 912 that follows the first embodiment of block 908 discussed above in which the “local” resource device provided by the accelerator device 708 was identified to the microvisor engine 706, and the communication channel between that “local” resource device/accelerator device 708 may have been previously established with the microvisor engine 706 at block 910, the microvisor engine 706 may perform resource functionality provisioning operations 1202 that include providing the resource functionality performed by the accelerator device 708 to the LCS 1002 via the communication channel, the API subsystem 706c, the ePF 1004, and the API subsystem 1002a.

Furthermore, as illustrated in FIG. 12B, in some embodiments the resource functionality provisioning operations 1202 may include data transfer operations 1202a between the DMA subsystem 706b in the microvisor engine 706 and the DMA subsystem 708a in the accelerator device 708. As such, microvisor engine 706 may configure memory system access (e.g., via an Input/Output Memory Management Unit (IOMMU)), and then use the DMA subsystem 706b to transmit data to the accelerator device 708 via the DMA subsystem 708a, and/or use the DMA subsystem 706b to receive data from the accelerator device 708 via the DMA subsystem 708a, as part of any of a variety of accelerator operations performed by the accelerator device 708.

With reference to FIG. 13C, in a second embodiment of block 912 that follows the second embodiment of block 908 discussed above in which the “remote” resource device provided by the BMS 710 was identified to the microvisor engine 706, and the communication channel between that “remote” resource device/BMS 710 was established with the microvisor engine 706 at block 910, the microvisor engine 706 may perform resource functionality provisioning operations 1304 that include providing the resource functionality performed by the BMS 710 to the LCS 1002 via the communication channel, the API subsystem 706c, the ePF 1004, and the API subsystem 1002a.

With reference to FIG. 14C, in a third embodiment of block 912 that follows the third embodiment of block 908 discussed above in which the “remote” resource device provided by the accelerator device 712/BMS 714 was identified to the microvisor engine 706, and the communication channel between that “remote” resource device/accelerator device 712/BMS 714 was established with the microvisor engine 706 at block 910, the microvisor engine 706 may perform resource functionality provisioning operations 1404 that include providing the resource functionality performed by the accelerator device 712 via the BMS 714 to the LCS 1002 via the communication channel, the API subsystem 706c, the ePF 1004, and the API subsystem 1002a.

As such, the ePF 1004 allows the LCS 1002 to be provided resource functionality performed by any of the accelerator device 708, the BMS 710, and the accelerator device 712/BMS 714. Furthermore, similarly as described by some of the inventors in U.S. patent application Ser. No. 18/160,738 referenced above, one of skill in the art in possession of the present disclosure will appreciate how the accelerator device 708, the BMS 710, or the accelerator device 712/BMS 714 may be used by multiple LCSs via their ePFs. As such, sharing of any of the accelerator device 708, the BMS 710, and the accelerator device 712/BMS 714 between LCSs is enabled via the ePFs described herein while allowing LCSs to use the conventional API subsystems provided for the accelerator device 708, the BMS 710, and the accelerator device 712/BMS 714.

Furthermore, similarly as described by some of the inventors in U.S. patent application Ser. No. 18/160,738 referenced above, the ePF 1004 may enable resource functionality required by the LCS 1002 via resource functionality available from combinations of the accelerator device 708, the BMS 710, and the accelerator device 712/BMS 714 (e.g., via the respective communication channels established as described above with each of the accelerator device 708, the BMS 710, and the accelerator device 712/BMS 714). As such, resource functionality presented by the ePF to the LCS 1002 may actually be performed by multiple resource devices.

Thus, systems and methods have been described that present resource functionality to an LCS using an ePF that interacts with an LCS API subsystem and allows for the execution of resource functionality requests received from that LCS API subsystem using any of a variety of resource devices. For example, the LCS ePF-enabled resource system of the present disclosure may include a resource system coupled to a resource management system and resource device(s) configured to provide resource functionality. The resource system includes a microvisor subsystem that the resource management system configures to provide an LCS and an ePF that is presented to the LCS as providing the resource functionality. When the microvisor subsystem receives an LCS request for the resource functionality from an LCS API subsystem in the LCS via the ePF, it transmits a microvisor request to the resource management system for the resource functionality that causes the resource management system to identify the resource device(s) for providing the resource functionality. Based on the identification of the resource device(s), the microvisor subsystem establishes a communication channel with each resource device, and provides the resource functionality to the LCS using the resource device(s) and via each communication channel, the ePF, and the LCS API subsystem. As such, resource devices that include conventional APIs that are designed for use with single user interfaces may be utilized by multiple LCSs without modification to those conventional APIs.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Logically Composed System (LCS) emulated Physical Function (ePF)-enabled resource system, comprising:
a resource management system;
at least one resource device that is configured to provide resource functionality;
a resource system that is coupled to the resource management system and the at least one resource device, wherein the resource system includes a microvisor subsystem that is configured to:
provide, in response to LCS configuration operations by the resource management system, a Logically Composed System (LCS) and an emulated Physical Function (ePF) that is presented to the LCS as providing the resource functionality;
receive, from an LCS Application Programming Interface (API) subsystem in the LCS via the ePF, an LCS request for the resource functionality;
transmit, to the resource management system, a microvisor request for the resource functionality that is configured to cause the resource management system to identify the at least one resource device for providing the resource functionality;
establish, with each of the at least one resource device based on the resource management system identifying the at least one resource device for providing the resource functionality, a respective communication channel; and
provide, to the LCS using the at least one resource device, the resource functionality via each respective communication channel, the ePF, and the LCS API subsystem.

2. The system of claim 1, wherein the at least one resource device is an accelerator device.

3. The system of claim 2, wherein the accelerator device is a graphics processing system.

4. The system of claim 1, wherein the at least one resource device includes a local resource device that the resource management system identifies for providing the resource functionality by instructing the microvisor subsystem to establish the respective communication channel with the local resource device.

5. The system of claim 1, wherein the at least one resource device includes a remote resource device that the resource management system identifies for providing the resource functionality by instructing the remote resource device to establish the respective communication channel with the microvisor subsystem.

6. The system of claim 5, wherein the microvisor subsystem includes a microvisor agent that is configured to establish the respective communication channel with the remote resource device via a remote resource agent provided for the remote resource device.

7. An Information Handling System (IHS), comprising:
a microvisor processing system; and
a microvisor memory system that is coupled to the microvisor processing system and that includes instructions that, when executed by the microvisor processing system, cause the microvisor processing system to provide a microvisor engine that is configured to:
provide, in response to LCS configuration operations by a resource management system that is coupled to the microvisor processing system, a Logically Composed System (LCS) and an emulated Physical Function (ePF) that is presented to the LCS as providing resource functionality;
receive, from an LCS Application Programming Interface (API) subsystem in the LCS via the ePF, an LCS request for the resource functionality;
transmit, to the resource management system, a microvisor request for the resource functionality that is configured to cause the resource management system to identify at least one resource device for providing the resource functionality;
establish, with each of the at least one resource device based on the resource management system identifying the at least one resource device for providing the resource functionality, a respective communication channel; and
provide, to the LCS using the at least one resource device, the resource functionality via each respective communication channel, the ePF, and the LCS API subsystem.

8. The IHS of claim 7, wherein the at least one resource device is an accelerator device.

9. The IHS of claim 8, wherein the accelerator device is a graphics processing system.

10. The IHS of claim 7, wherein the at least one resource device includes a local resource device that the resource management system identifies for providing the resource functionality by instructing the microvisor engine to establish the respective communication channel with the local resource device.

11. The IHS of claim 10, wherein the microvisor engine includes a microvisor API subsystem that is configured to establish the respective communication channel with the local resource device.

12. The IHS of claim 7, wherein the at least one resource device includes a remote resource device that the resource management system identifies for providing the resource functionality by instructing the remote resource device to establish the respective communication channel with the microvisor engine.

13. The IHS of claim 12, wherein the microvisor engine includes a microvisor agent that is configured to establish the respective communication channel with the remote resource device via a remote resource agent provided for the remote resource device.

14. A method for enabling resources for a Logically Composed System (LCS) using emulated Physical Functions (ePFs), comprising:
providing, by a microvisor subsystem in response to LCS configuration operations by a resource management system, a Logically Composed System (LCS) and an emulated Physical Function (ePF) that is presented to the LCS as providing resource functionality;
receiving, by the microvisor subsystem from an LCS Application Programming Interface (API) subsystem in the LCS via the ePF, an LCS request for the resource functionality;
transmitting, by the microvisor subsystem to the resource management system, a microvisor request for the resource functionality that is configured to cause the resource management system to identify at least one resource device for providing the resource functionality;
establishing, by the microvisor subsystem with each of the at least one resource device based on the resource management system identifying the at least one resource device for providing the resource functionality, a respective communication channel; and
providing, by the microvisor subsystem to the LCS using the at least one resource device, the resource functionality via each respective communication channel, the ePF, and the LCS API subsystem.

15. The method of claim 14, wherein the at least one resource device is an accelerator device.

16. The method of claim 15, wherein the accelerator device is a graphics processing system.

17. The method of claim 14, wherein the at least one resource device includes a local resource device that the resource management system identifies for providing the resource functionality by instructing the microvisor subsystem to establish the respective communication channel with the local resource device.

18. The method of claim 14, wherein the microvisor subsystem includes a microvisor API subsystem that establishes the respective communication channel with the local resource device.

19. The method of claim 14, wherein the at least one resource device includes a remote resource device that the resource management system identifies for providing the resource functionality by instructing the remote resource device to establish the respective communication channel with the microvisor subsystem.

20. The method of claim 19, wherein the microvisor subsystem includes a microvisor agent that is configured to establish the respective communication channel with the remote resource device via a remote resource agent provided for the remote resource device.
